(19) United States
(12) Patent Application Publication
(10) Pub. No.: US 2024/0359676 A1
(43) Pub. Date: Oct. 31, 2024

(54) ELECTRONIC BRAKE SYSTEM AND METHOD OF CONTROLLING THE SAME

(71) Applicant: HL MANDO CORPORATION, Gyeonggi-do (KR)

(72) Inventor: Yongseong JANG

(21) Appl. No.: 18/242,001

(22) Filed: Sep. 5, 2023

(30) Foreign Application Priority Data
Apr. 26, 2023 (KR) 10-2023-0054606

(51) Int. Cl. B60T 13/68; B60T 7/04; B60T 8/18; B60T 17/22

(52) U.S. Cl. CPC B60T 13/686; B60T 7/042; B60T 8/1881; B60T 17/22; B60T 2270/406

(57) ABSTRACT

An exemplary embodiment of the present disclosure provides an electronic brake system, which includes different first and second hydraulic circuits configured to transmit hydraulic pressure, which is discharged in a low-pressure pressing mode state or a high-pressure pressing operation mode state of a hydraulic pressure supply device, to a wheel cylinder provided on at least one vehicle wheel, the electronic brake system including a plurality of valves provided in hydraulic pressure flow path that connects the hydraulic pressure supply device and the first and second hydraulic circuits, the plurality of valves being configured to regulate hydraulic pressure, a volume detection part configured to detect an input volume value of a pressure chamber produced when a motor piston is moved by a rotational force of a motor corresponding to a pedal effort measured by a pedal displacement sensor, and compute and detect, as a circuit volume value, a pressure value of the second hydraulic circuit measured by a pressure sensor, a determination part configured to compare the circuit volume value with the input volume value detected by the volume detection part, determine whether a predetermined condition is satisfied, and determine whether a leakage occurs in the second hydraulic circuit, and a control part configured to perform control to stop the low-pressure pressing mode, switch the mode to the high-pressure pressing operation mode, and detect a leakage occurrence valve among the plurality of valves when the determination part determines that a leakage occurs.

### CROSS-REFERENCE TO RELATED APPLICATIONS

This application claims benefit and priority to Korean Patent Application No. 10-2023-0054606, filed on Apr. 26, 2023, with the Korean Intellectual Property Office, the disclosure of which is incorporated herein in its entirety by reference.

### TECHNICAL FIELD

The present disclosure relates to an electronic brake system and a method of controlling the same, and more particularly, to an electronic brake system and a method of controlling the same, which are capable of accurately detecting whether a leakage occurs from a secondary circuit cut valve (hereinafter, referred to as a ‘CUTV(S)’) of an integrated dynamic brake (hereinafter, referred to as an ‘IDB’) system for a vehicle, and providing stability for a driver by ensuring a braking force even when a leakage is detected.

### BACKGROUND

Vehicles are essentially equipped with brake systems for braking the vehicles. Recently, various types of systems for obtaining a higher, stabler braking force have been proposed.

Examples of the brake systems include an anti-lock brake system (ABS) configured to prevent a slip of a wheel during a braking process, a brake traction control system (BTCS) configured to prevent a slip of a driving wheel when a vehicle suddenly or rapidly accelerates, and an electronic stability control system (ESC) configured to stably maintain a traveling state of a vehicle by controlling a brake fluid pressure with a combination of the anti-lock brake system and the traction control.

An integrated dynamic brake (hereinafter, referred to as an ‘IDB’) system for a vehicle, which is made by combining an electronic booster and an electronic control device of an electric vehicle has been developed.

In general, an electronic brake system includes a hydraulic pressure supply device that supplies pressure to a wheel cylinder by receiving an electrical signal related to a driver's braking intention from a pedal displacement sensor that detects a displacement of a brake pedal when the driver presses the brake pedal.

The hydraulic pressure supply device is configured to generate a braking pressure by operating a motor in accordance with a pedal effort of a brake pedal. In this case, the braking pressure is generated by covering a rotational force of the motor into a rectilinear motion and pressing the piston.

The brake system includes a pedal simulator that receives hydraulic pressure in accordance with the driver's pedal effort and provides pedal feel to the driver to measure the pedal effort of the pedal applied by the driver.

Therefore, the electronic brake system having the hydraulic pressure supply device generates braking pressure on the basis of a sensor value of a pedal position sensor obtained in accordance with the pedal effort of the pedal applied by the driver, and the pedal simulator operates on the basis of the pedal position sensor value.

The electronic brake system needs to provide a braking force at a predetermined level or higher even in a situation in which some components in the system do not operate.

In particular, in case that a leakage occurs from a cut valve CUTV of a secondary circuit of the electronic brake system, the driver feels pedal heterogeneity, and braking performance of the electronic brake system deteriorates, such that the braking force cannot be provided as much as the driver's intention.

Because a liquid is not discharged to the outside in case that a leakage occurs in the circuit, there is a problem in that the leakage cannot be visually identified, and the leakage occurrence position cannot be accurately recognized.

### SUMMARY

An exemplary embodiment of the present disclosure provides an electronic brake system, which includes different first and second hydraulic circuits configured to transmit hydraulic pressure, which is discharged in a low-pressure pressing mode state or a high-pressure pressing operation mode state of a hydraulic pressure supply device, to a wheel cylinder provided on at least one vehicle wheel, the electronic brake system including: a plurality of valves provided in hydraulic pressure flow path that connects the hydraulic pressure supply device and the first and second hydraulic circuits, the plurality of valves being configured to regulate hydraulic pressure; a volume detection part configured to detect an input volume value of a pressure chamber produced when a motor piston is moved by a rotational force of a motor corresponding to a pedal effort measured by a pedal displacement sensor, and compute and detect, as a circuit volume value, a pressure value of the second hydraulic circuit measured by a pressure sensor; a determination part configured to compare the circuit volume value with the input volume value detected by the volume detection part, determine whether a predetermined condition is satisfied, and determine whether a leakage occurs in the second hydraulic circuit; and a control part configured to perform control to stop the low-pressure pressing mode, switch the mode to the high-pressure pressing operation mode, and detect a leakage occurrence valve among the plurality of valves when the determination part determines that a leakage occurs.

In this case, particularly, the pressure sensor may measure hydraulic pressure to be transmitted to at least one wheel cylinder of the second hydraulic circuit, and the pedal displacement sensor may measure a driver's pedal effort.

In this case, particularly, the determination part may determine whether a leakage occurs in the second hydraulic circuit by comparing the input volume value and the circuit volume value, determining whether the volume value satisfies the predetermined condition, comparing the pressure value of the second hydraulic circuit with target pressure, and determining whether the predetermined condition is satisfied.

In this case, particularly, the determination part may determine whether a leakage occurs by performing, at least three times, a process of determining whether a leakage occurs in the second hydraulic circuit.

In this case, particularly, the plurality of valves may include a second cut valve, a first control valve, a second control valve, a third control valve, a fourth control valve, and a fifth control valve between the hydraulic pressure supply device and the second hydraulic circuit.

In this case, particularly, when the determination part determines that a leakage occurs, the control part may switch the mode to the high-pressure pressing operation mode of the hydraulic pressure supply device, operate the first control valve of the second hydraulic circuit in a closed state, operate the second control valve in an open state, and then perform control to allow the determination part to repeatedly determine whether a leakage occurs in the second hydraulic circuit.

In this case, particularly, when the determination part determines that no leakage occurs, the control part may detect the second control valve as the leakage occurrence valve.

In this case, particularly, when the determination part determines that a leakage occurs, the control part may detect the second cut valve as the leakage occurrence valve.

In this case, particularly, when the determination part determines that a leakage occurs, the control part may perform control to open the first and second cut valves and switch the mode to a fall-back mode.

In this case, particularly, when the determination part determines that a leakage occurs, the control part may record diagnostic trouble code (DTC) information, turn on a warning lamp, and switch a state to an IDC control inhibition state after a braking cycle is ended.

Another exemplary embodiment of the present disclosure provides a method of controlling an electronic brake system, which includes different first and second hydraulic circuits configured to transmit hydraulic pressure, which is discharged in a low-pressure pressing mode state or a high-pressure pressing operation mode state of a hydraulic pressure supply device, to a wheel cylinder provided on at least one vehicle wheel, the method including: detecting an input volume value of a pressure chamber produced when a motor piston is moved by a rotational force of a motor corresponding to a pedal effort measured by a pedal displacement sensor, and computing and detecting, as a circuit volume value, a pressure value of the second hydraulic circuit measured by a pressure sensor; comparing the circuit volume value with the detected input volume value, determining whether the volume value satisfies a predetermined condition, and determining whether a leakage occurs in the second hydraulic circuit; and performing control to stop the low-pressure pressing mode, switch the mode to the high-pressure pressing operation mode, and detect a leakage occurrence valve among the plurality of valves when the determination result, in the determining of whether a leakage occurs, indicates that a leakage occurs.

In this case, particularly, the pressure sensor may measure hydraulic pressure to be transmitted to at least one wheel cylinder of the second hydraulic circuit, and the pedal displacement sensor may measure a driver's pedal effort.

In this case, particularly, in the determining of whether a leakage occurs in the second hydraulic circuit, whether a leakage occurs in the second hydraulic circuit may be determined by comparing the circuit volume value with the input volume value, determining whether the predetermined condition is satisfied, comparing a pressure value of the second hydraulic circuit with target pressure, and then determining whether the predetermined condition is satisfied.

In this case, particularly, in the determining of whether a leakage occurs in the second hydraulic circuit, a process of determining whether a leakage occurs in the second hydraulic circuit may be performed at least three times.

In this case, particularly, during the process of determining whether a leakage occurs in the second hydraulic circuit by performing the process at least three times, the process of determining whether a leakage occurs may be performed so that the time required to determine the occurrence of a first leakage is shorter than the time required to determine the occurrence of a second leakage or a later leakage.

In this case, particularly, the method may further include: switching the mode to the high-pressure pressing operation mode of the hydraulic pressure supply device, operating a first control valve of the second hydraulic circuit in a closed state, operating a second control valve in an open state, and then performing control to allow a determination part to repeatedly determine whether a leakage occurs in the second hydraulic circuit when the determination result, in the determining of whether a leakage occurs in the second hydraulic circuit, indicates that a leakage occurs.

In this case, particularly, the second control valve may be detected as the leakage occurrence valve when the determination result, in the determining of whether a leakage occurs in the second hydraulic circuit, indicates that no leakage occurs.

In this case, particularly, a second cut valve may be detected as the leakage occurrence valve when the determination result, in the determining of whether a leakage occurs in the second hydraulic circuit, indicates that a leakage occurs.

In this case, particularly, the method may further include: performing control to open first and second cut valves and switch the mode to a fall-back mode when the leakage occurrence valve is detected in the determining of whether a leakage occurs in the second hydraulic circuit.

In this case, particularly, the method may further include: after the switching of the mode to the fall-back mode, recording diagnostic trouble code (DTC) information, turning on a warning lamp, and switching a state to an IDC control inhibition state after a braking cycle is ended.

According to any one of the technical solutions of the present disclosure, it is possible to accurately detect whether a leakage occurs from the secondary circuit cut valve (hereinafter, referred to as a ‘CUTV(S)’) of an integrated dynamic brake (hereinafter, referred to as an ‘IDB’) system for a vehicle, and provide stability for the driver by ensuring the braking force even when a leakage is detected.

In addition, after a failure occurs, the diagnostic trouble code (DTC) may be recorded, the warning lamp may be turned on to notify the driver of the failure situation, and then the control inhibition state may be set to ensure the braking force as much as the driver's pedal effort.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view schematically illustrating a hydraulic circuit diagram illustrating a state in which an electronic brake system according to an embodiment of the present disclosure does not perform a braking operation.

FIG. 2 is a view schematically illustrating a configuration of the electronic brake system according to the embodiment of the present disclosure.

FIG. 3 is a view schematically illustrating a hydraulic circuit diagram illustrating a state in which the electronic brake system according to the embodiment of the present disclosure performs the braking operation in a low-pressure pressing mode.

FIG. 4 is a view illustrating a plurality of valve operating states in FIG. 3.

FIG. 5 is a graph illustrating a change in braking state corresponding to a pressing operation during the braking operation in FIG. 3.

FIG. 6 is a view illustrating a time diagram related to a process of detecting a leakage in FIG. 3.

FIG. 7 is a view schematically illustrating a hydraulic circuit diagram illustrating a state in which the electronic brake system according to the embodiment of the present disclosure performs a high-pressure pressing operation.

FIG. 8 is a view illustrating a plurality of valve operating states in FIG. 7.

FIG. 9 is a graph illustrating a change in braking state corresponding to a pressing operation during the braking operation in FIG. 7.

FIG. 10 is a view schematically illustrating a hydraulic circuit diagram illustrating a fall-back state of the electronic brake system according to the embodiment of the present disclosure.

FIG. 11 is a view illustrating a plurality of valve operating states in FIG. 10.

FIG. 12 is a graph illustrating a change in braking state corresponding to a pressing operation during the braking operation in FIG. 10.

FIG. 13 is a flowchart schematically illustrating a method of controlling the electronic brake system according to the embodiment of the present disclosure.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings so that those with ordinary skill in the art to which the present disclosure pertains may easily carry out the exemplary embodiments. However, the present disclosure may be implemented in various different ways and is not limited to the embodiments described herein. Further, a part irrelevant to the description will be omitted in the drawings in order to clearly describe the present disclosure, and similar constituent elements will be designated by similar reference numerals throughout the specification. In addition, in the description with reference to the drawings, the components with the same name may be denoted by different reference numerals in the different drawings. The reference numerals are provided only for convenience of description, but the concept, feature, function, or effect of the component is not construed as being limited by the reference numerals.

Throughout the specification, when one constituent element is referred to as being “connected to” another constituent element, one constituent element can be “directly connected to” the other constituent element, and one constituent element can also be “electrically connected to” the other element with other elements therebetween. In addition, unless explicitly described to the contrary, the word “comprise/include” and variations such as “comprises/includes” or “comprising/including” will be understood to imply the inclusion of stated elements, not the exclusion of any other elements. However, the word does not preclude the presence or addition of one or more other features, integers, steps, operations, elements, components, and/or combinations thereof.

In the present specification, the terms ‘part,’ ‘portion,’ or ‘module’ include a unit realized by hardware or software or a unit realized by hardware and software. A single unit may be realized by using two or more types of hardware, or two or more units may be realized by a single type of hardware.

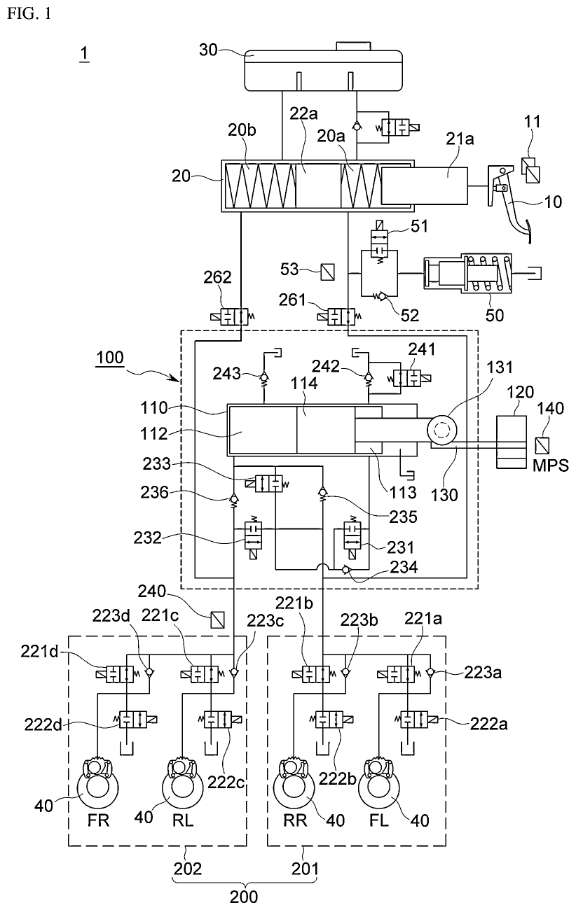

FIG. 1 is a view schematically illustrating a configuration of a hydraulic circuit diagram illustrating a state in which an electronic brake system according to the embodiment does not perform a braking operation.

With reference to FIG. 1, an electronic brake system 1 includes a reservoir 30 coupled to an upper portion of a master cylinder 20 and configured to store oil, an input rod 12 configured to press the master cylinder 20 in accordance with a pedal effort of a brake pedal 10, wheel cylinders 40 configured to receive hydraulic pressure and respectively brake vehicle wheels RR, RL, FR, and FL, a pedal displacement sensor 11 configured to detect a displacement of the brake pedal 10, and a simulation device 50 configured to provide a reaction force in accordance with the pedal effort of the brake pedal 10.

The master cylinder 20 may have at least one chamber and generate hydraulic pressure. For example, the master cylinder 20 may include a first master chamber 20a and a second master chamber 20b.

The electronic brake system may include a hydraulic pressure supply device 100 configured to mechanically operate by receiving electrical signals related to a driver's braking intention from the master cylinder 20 configured to generate hydraulic pressure, the wheel cylinders 40 configured to receive hydraulic pressure and respectively brake the vehicle wheels RR, RL, FR, and FL, and the pedal displacement sensor 11 configured to detect the displacement of the brake pedal 10. The electronic brake system may include a hydraulic pressure control unit 200 including first and second hydraulic circuits 201 and 202 configured to control flows of hydraulic pressure to be transmitted to the wheel cylinders 40 respectively provided for each of the two vehicle wheels among the vehicle wheels RR, RL, FR, and FL. The electronic brake system may include a first cut valve 261 provided in a first back-up flow path 251, which connects a first hydraulic pressure port 24a and a first hydraulic circuit 201, and configured to control the flow of hydraulic pressure, a second cut valve 262 provided in a second back-up flow path 252, which connects a second hydraulic pressure port 24b and a second hydraulic circuit 202, and configured to control the flow of hydraulic pressure, and an electronic control unit (ECU) 400 configured to control the hydraulic pressure supply device 100 and the valves on the basis of hydraulic pressure information and pedal displacement information.

In this case, for example, the first and second cut valves 261 and 262 may each be configured as a normal open-type solenoid valve that is opened in a normal state and operated to be closed when receiving a closing signal.

Therefore, when the first and second cut valves 261 and 262 are opened, the hydraulic pressure provided from the master cylinder 20 may be supplied to the wheel cylinders 40 through the first and second back-up flow paths 251 and 252.

The hydraulic pressure supply device 100 may include a hydraulic pressure provision unit 110 configured to provide oil pressure to be transmitted to the wheel cylinders 40, a motor 120 configured to generate a rotational force in response to an electrical signal of the pedal displacement sensor 11, and a power conversion part 130 configured to convert a rotational motion of the motor 120 into a rectilinear motion and transmit the rectilinear motion to the hydraulic pressure provision unit 110. Alternatively, the hydraulic pressure provision unit 110 may be operated by pressure provided by the high-pressure accumulator instead of driving power supplied from the motor 120.

The electronic brake system 1 may additionally include various valves.

More specifically, the electronic brake system may include inlet valves 221 (221a, 221b, 221c, and 221d) configured to regulate a flow rate of hydraulic pressure discharged from the hydraulic pressure supply device 100.

A simulator valve 54 may be provided in a flow path that connects a rear end of a simulation chamber 51 and the reservoir 30. In this case, the simulator valve 54 may be configured as a normal closed-type solenoid valve that is kept in a closed state at ordinary times. When the driver applies the pedal effort to the brake pedal 10, the simulator valve 54 may be opened and transfer oil in the simulation chamber 51 to the reservoir 30. In addition, a simulator check valve 55 may be installed between a pedal simulator and the reservoir 30 and connected in parallel with the simulator valve 54. The simulator check valve 55 may allow the flow of oil in the reservoir 30 to the simulation chamber 51 and block the flow of oil in the simulation chamber 51 to the reservoir 30 through the flow path in which the check valve 55 is installed.

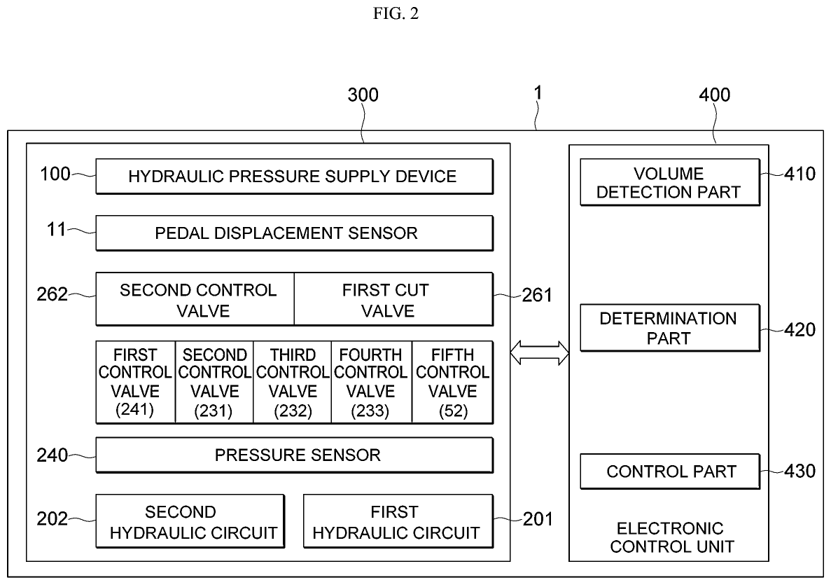

FIG. 2 is a view schematically illustrating a configuration of the electronic brake system of the present disclosure.

As illustrated in FIG. 2, the configuration of the electronic brake system of the present disclosure broadly includes a brake device 300 and an electronic control unit 400. The brake device 300 is schematically illustrated as having essential components among the components of the hydraulic circuit diagram in FIG. 1. A detailed description will be omitted with reference to FIG. 1.

First, the brake device 300 may include the hydraulic pressure supply device 100, the pedal displacement sensor 11, the first cut valve 261, the second cut valve 262, a plurality of valves including a first control valve 241, a second control valve 231, a third control valve 232, a fourth control valve 233, and a fifth control valve 51, a pressure sensor 240, the first hydraulic circuit 201, and the second hydraulic circuit 202.

The hydraulic pressure supply device 100 transmits hydraulic pressure, which is discharged in a low-pressure pressing mode state or a high-pressure pressing operation mode state, to the wheel cylinders provided on at least one vehicle wheel.

The pedal displacement sensor 11 serves to measure the driver's pedal effort of the brake pedal 10, and the pedal displacement sensor 11 detects the displacement and provides the driver's braking intention as an electrical signal.

The first and second cut valves 261 and 262 supply the hydraulic pressure, which is provided from the master cylinder 20, to the wheel cylinders 40. In this case, the first and second cut valves 261 and 262 may each be configured as a normal open-type solenoid valve that is opened in a normal state and operated to be closed when receiving a closing signal.

The first control valve 241, the second control valve 231, the third control valve 232, the fourth control valve 233, and the fifth control valve 51 are provided in a hydraulic pressure flow path, which connects the hydraulic pressure supply device 100, the first hydraulic circuit 201, and the second hydraulic circuit 202, and regulate hydraulic pressure.

The pressure sensor 240 measures hydraulic pressure transmitted to at least one wheel cylinder of the second hydraulic circuit.

The first hydraulic circuit 201 and the second hydraulic circuit 202 control the flows of hydraulic pressure to be transmitted to the wheel cylinders 40 provided for each of the two vehicle wheels among the vehicle wheels RR, RL, FR, and FL.

The electronic control unit 400 may include a volume detection part 410, a determination part 420, and a control part 430.

The volume detection part 410 detects an input volume value of a pressure chamber that is produced when the motor piston is moved by the rotational force of the motor corresponding to the pedal effort measured by the pedal displacement sensor 11. The volume detection part 410 computes and detects a circuit volume value as a pressure value of the second hydraulic circuit 202 measured by the pressure sensor 240.

More specifically, the input volume value of the volume detection part 410 is a volume value produced as the motor piston of the hydraulic pressure supply device 100 moves in accordance with the pedal effort measured by the pedal displacement sensor 11. In this case, the volume value produced by the volume detection part 410 is detected by applying a preset volume data value in accordance with a motion of the motor piston.

The circuit volume value is computed by estimating a volume value corresponding to a pressure value of the second hydraulic circuit 202 (secondary circuit pressure) measured by the pressure sensor 240. In this case, the circuit volume value is an estimated value made by calculating a volume in the circuit, and the circuit volume value may be detected in accordance with the preset circuit volume data value.

The determination part 420 compares the circuit volume value with an input volume value detected by the volume detection part 410, determines whether the volume value satisfies a predetermined condition, and then determines whether a leakage occurs in the second hydraulic circuit.

When the determination part 420 determines that a leakage occurs, the control part 430 performs control to stop the low-pressure pressing mode, switch the mode to the high-pressure pressing operation mode, and then detect a leakage occurrence valve among the plurality of valves.

In this case, the detailed description related to the configurations of the volume detection part 410, the determination part 420, and the control part 430 will be described with reference to the operations for respective modes.

### Description of Operation in Low-Pressure Pressing Mode

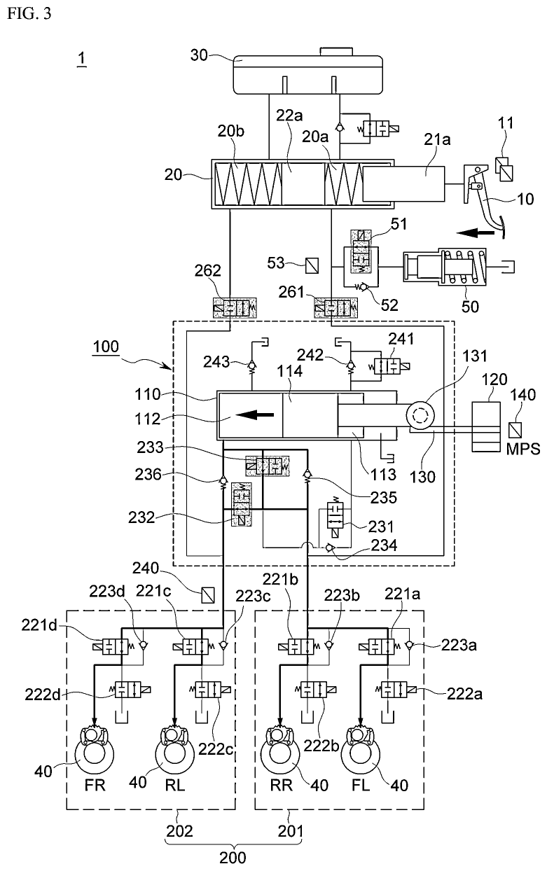

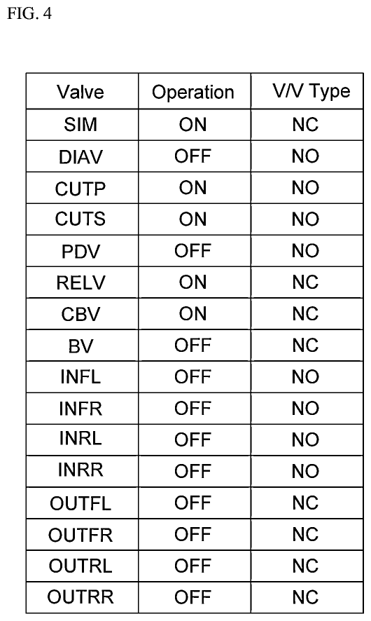

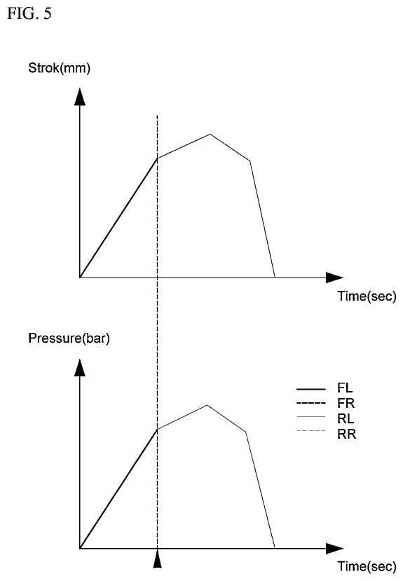

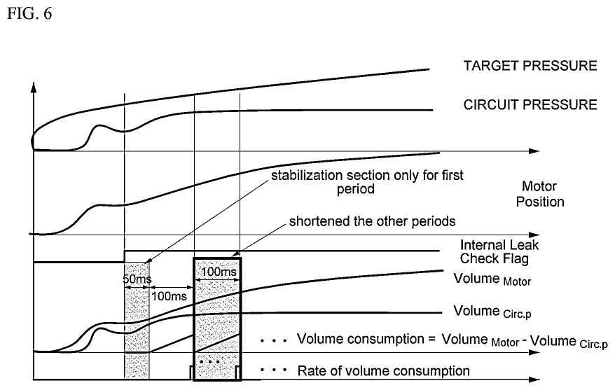

FIG. 3 is a view schematically illustrating a hydraulic circuit diagram illustrating a state in which the electronic brake system according to the embodiment of the present disclosure performs the braking operation in a low-pressure pressing mode, FIG. 4 is a view illustrating a plurality of valve operating states in FIG. 3, FIG. 5 is a graph illustrating a change in braking state corresponding to a pressing operation during the braking operation in FIG. 3, and FIG. 6 is a view illustrating a time diagram related to a process of detecting a leakage in FIG. 3.

As illustrated in FIG. 3, in the low-pressure pressing mode state, the determination part 420 calculates a difference between the circuit volume value and the input volume value detected by the volume detection part 410, determines whether the volume value satisfies the predetermined condition, and then determines whether a leakage occurs in the second hydraulic circuit 202.

More specifically, the determination part 420 calculates a difference between the detected input volume value and the detected circuit volume value, determines whether the calculated volume value satisfies the leakage condition, and then finally determines whether a leakage occurs in the second hydraulic circuit by comparing the pressure value of the second hydraulic circuit with the target pressure and determining whether a condition, in which a second circuit pressure value is less than 80% of a target pressure value, is satisfied.

The determination part 420 calculates a difference between the circuit volume value and the input volume value, which is detected at least three times, to determine the occurrence of the leakage in the second hydraulic circuit, and then determines a volume caused by the occurrence of leakage on the basis of the value.

In this case, because the time required to determine the occurrence of the leakage is directly related to under-braking, a stabilization section is provided for 50 ms only during the first determination process in order to minimize the determination time and improve the detection performance. That is, in case that the stabilization section is not provided, an instantaneous error may occur at the time of calculating a leakage rate. Further, whether a leakage occurs is continuously determined a total of two or more times for 100 ms.

When the determination part 420 determines that a leakage occurs, the control part 430 stops the low-pressure pressing mode of the hydraulic pressure supply device, switches the mode to the high-pressure pressing operation mode, and then detects a leakage occurrence valve among the plurality of control valves.

More specifically, when the determination part 420 determines that a leakage occurs, the control part 430 stops the low-pressure pressing mode of the hydraulic pressure supply device 100 and performs control to switch the mode to the high-pressure pressing operation mode. In this case, the control part 430 detects the control valve from which a leakage occurs among the plurality of control valves. For example, because it is impossible to accurately determine the valve from which a leakage occurs among many valves that constitute the IDB system, the leakage occurrence valve is detected by specifying the valve while excluding the valves one by one.

Meanwhile, the plurality of control valves may be provided between the hydraulic pressure supply device 100 and the first and second hydraulic circuits 201 and 202 and include the first cut valve 261, the second cut valve 262, the first control valve 241, the second control valve 231, the third control valve 232, the fourth control valve 233, and the fifth control valve 54.

The first control valve 241 (PDV) may be configured as a solenoid valve capable of bidirectionally controlling the flow of oil between a second pressure chamber 113 and the reservoir 30. The first control valve 241 may be configured as a normal open-type solenoid valve that is opened in a normal state and operated to be closed when receiving a closing signal from the control part 430.

The second control valve 231 (BV) may be configured as a bidirectional control valve configured to control the flow of oil between the second pressure chamber 113 and the first hydraulic circuit 201. In this case, the second control valve 231 may be configured as a normal closed-type solenoid valve that is closed at ordinary times and operated to be opened while receiving an opening signal from the control part 430.

The third control valve 232 and the fourth control valve 233 may each be configured as a normal closed-type solenoid valve that is closed at ordinary times and operated to be opened while receiving an opening signal from the control part 430.

When a check valve is abnormal, the third control valve 232 and the fourth control valve 233 are operated to be opened, such that hydraulic pressure in a first pressure chamber 112 may be transmitted to both the first hydraulic circuit 201 and the second hydraulic circuit 202.

The third control valve 232 (CBV) and the fourth control valve 233 (RELV) may be operated to be opened when hydraulic pressure is discharged from the wheel cylinder 40 and transmitted to the first pressure chamber 112.

The fifth control valve 54 may be configured as a normal closed-type solenoid valve that is kept in a closed state at ordinary times the simulator valve 54. When the driver applies the pedal effort to the brake pedal 10, the simulator valve 54 may be opened and transfer oil in the simulation chamber 51 to the reservoir 30.

When the determination part 420 determines that a leakage occurs in the high-pressure pressing operation mode state, the control part 430 performs control to open the first cut valve 261 and the second cut valve 262 and switch the mode to a fall-back mode. In this case, the fall-back mode may be a control inhibition state.

In this case, in a detected braking cycle, the control part 430 opens the first cut valve (CUTV (P)) 261 and the second cut valve (CUTV(S)) 262 to ensure a braking force higher than a braking force in the fall-back mode by adding a force, which is applied by the motor, to the pedal effort applied to the pedal by the driver.

When the determination part determines that a leakage occurs, the control part 430 records diagnostic trouble code (DTC) information and turns on a warning lamp so that the driver recognizes the occurrence of the leakage.

### Description of Operation in High-Pressure Pressing Operation Mode

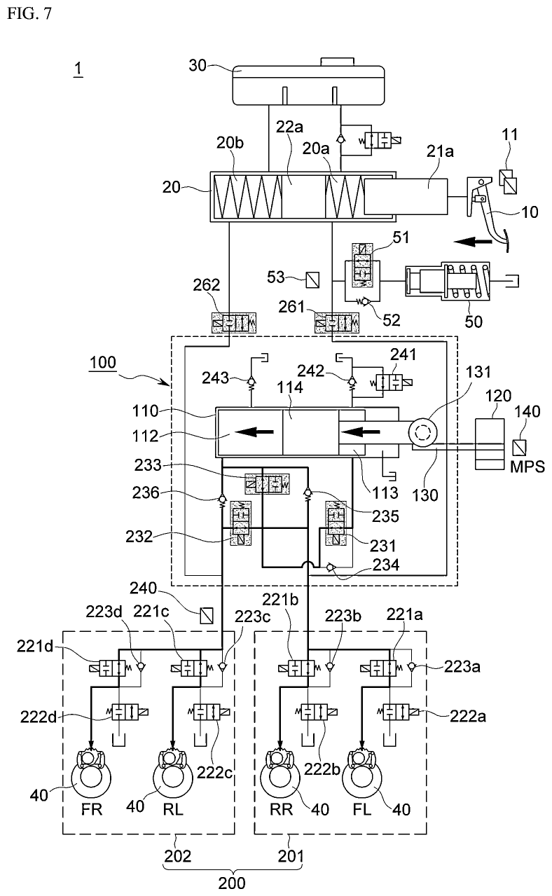

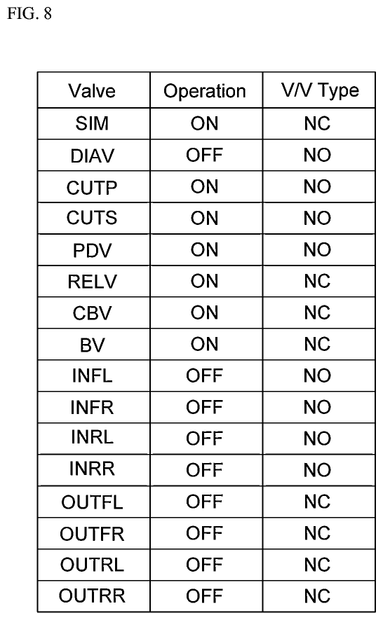

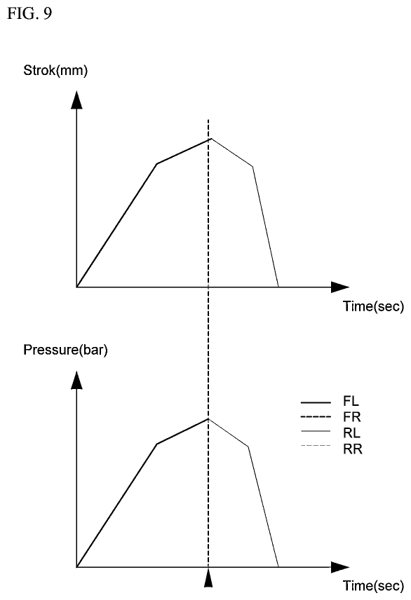

FIG. 7 is a view schematically illustrating a hydraulic circuit diagram illustrating a state in which the electronic brake system according to the embodiment of the present disclosure performs a high-pressure pressing operation mode, FIG. 8 is a view illustrating a plurality of valve operating states in FIG. 7, and FIG. 9 is a graph illustrating a change in braking state corresponding to a pressing operation during the braking operation in FIG. 7.

First, as illustrated in FIG. 7, in the high-pressure pressing operation mode, the first to fifth control valves 241, 231, 232, 233, and 54 of the second hydraulic circuit 202 operate to detect the control valve from which a leakage occurs among the plurality of control valves. The first to fifth control valves 241, 231, 232, 233, and 54 operate in a normal-closed state and a normal-open state in accordance with valve types, and then the control part performs control so that the determination part 420 consistently and repeatedly determines whether a leakage occurs in the second hydraulic circuit 202.

For example, because the first control valve 241 is the normal open type, as illustrated in FIG. 8, the first control valve 241 switches to the closed state when operating. Because the second control valve 231 is in the normal closed state, the second control valve 231 switches to the open state when operating.

The third control valve 232, the fourth control valve 233, and the fifth control valve 54 are in the normal close state, the third control valve 232, the fourth control valve 233, and the fifth control valve 54 switch to the open state when operating.

In other words, unlike the low-pressure pressing mode of the hydraulic pressure supply device, the second control valve 231 (BV) is opened, and the first control valve (PDV) 241 is closed in the high-pressure pressing operation mode. That is, when the leakage is eliminated while the process of detecting a leakage is performed when the control is performed in the high-pressure pressing operation mode, the leakage point is determined as the second control valve (BV) because the first control valve 241 is in the closed state.

However, when a leakage continuously occurs even though the mode has been switched to the high-pressure pressing operation mode, it may be determined that a leakage occurs in the second cut valve (CUTS).

### Description of Operation in Fall-Back Mode

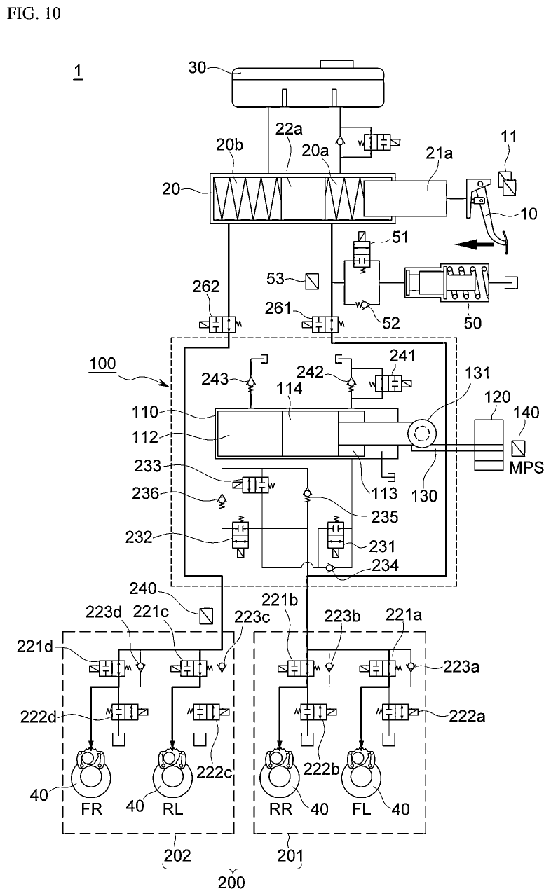

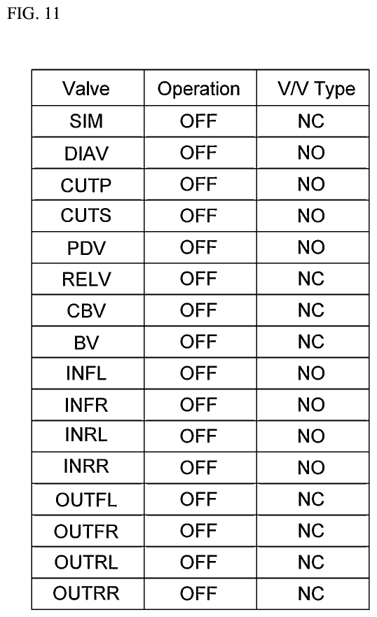

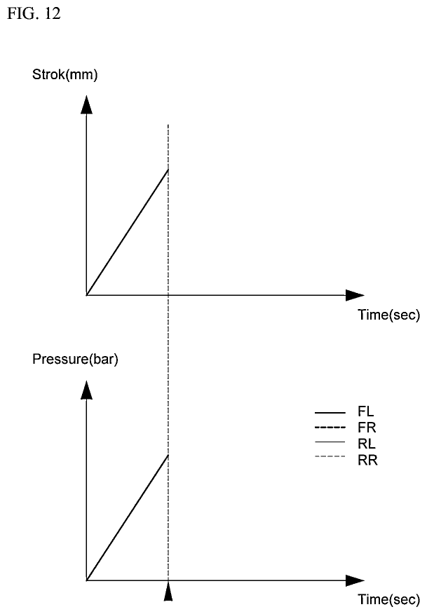

FIG. 10 is a view schematically illustrating a hydraulic circuit diagram illustrating a fall-back state of the electronic brake system according to the embodiment of the present disclosure, FIG. 11 is a view illustrating a plurality of valve operating states in FIG. 10, and FIG. 12 is a graph illustrating a change in braking state corresponding to a pressing operation during the braking operation in FIG. 10.

As illustrated in FIG. 10, when the determination part 420 determines that a leakage occurs in the high-pressure pressing operation mode state, the control part 430 performs control to open the first cut valve 261 and the second cut valve 262 and switch the mode to a fall-back mode. In this case, the fall-back mode may be a control inhibition state.

For example, as illustrated in FIG. 11, in the fall-back mode that is the control inhibition state, the first control valve 241 is the normal open type, and the second control valve 231, the third control valve 232, the fourth control valve 233, and the fifth control valve 54 are kept in the normal closed state.

In this case, in a detected braking cycle, the control part 430 normally opens the first cut valve (CUTV (P)) 261 and the second cut valve (CUTV (S)) 262 to ensure a braking force higher than a braking force in the fall-back mode by adding a force, which is applied by the motor, to the pedal effort applied to the pedal by the driver.

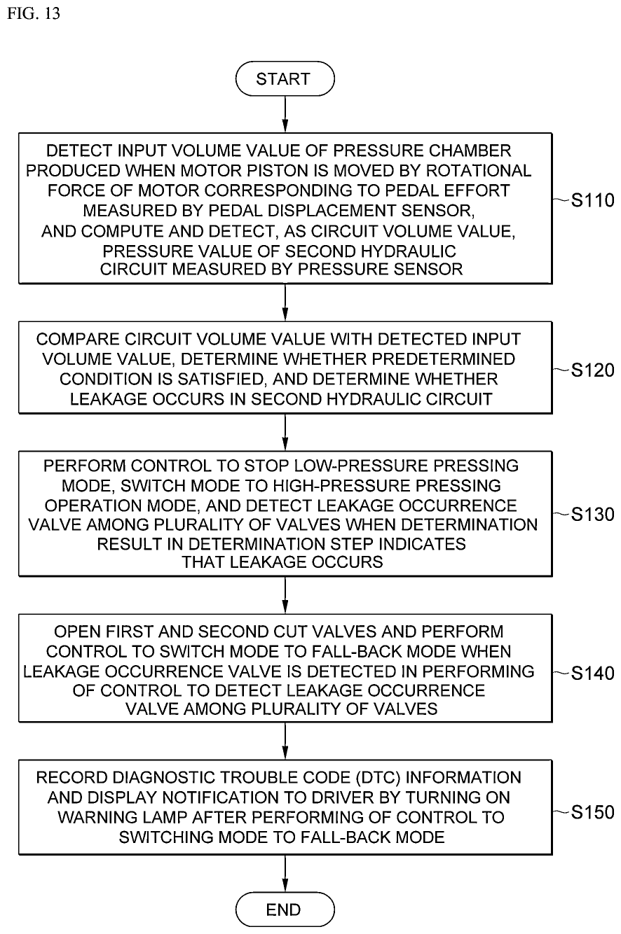

FIG. 13 is a flowchart schematically illustrating a method of controlling the electronic brake system according to the embodiment of the present disclosure.

As illustrated in FIG. 13, a method of controlling the electronic brake system according to the embodiment of the present disclosure performs, first, a step of detecting an input volume value of the pressure chamber produced when the motor piston is moved by a rotational force of the motor corresponding to the pedal effort measured by the pedal displacement sensor, and computing and detecting, as a circuit volume value, a pressure value of the second hydraulic circuit measured by the pressure sensor (S110).

More specifically, the input volume value is a volume value produced as the motor piston of the hydraulic pressure supply device 100 moves in accordance with the pedal effort measured by the pedal displacement sensor 11. In this case, the volume value produced by the volume detection part 410 is detected by applying a preset volume data value in accordance with a motion of the motor piston.

The circuit volume value is computed by estimating a volume value corresponding to a pressure value of the second hydraulic circuit 202 (secondary circuit pressure) measured by the pressure sensor 240. In this case, the circuit volume value is an estimated value made by calculating a volume in the circuit, and the circuit volume value may be detected in accordance with the preset circuit volume data value.

Next, the method performs a step of calculating a difference between the detected input volume value and the circuit volume value, determining whether the volume value satisfies the predetermined condition, and then determining whether a leakage occurs in the second hydraulic circuit (S120).

More specifically, the determination part 420 calculates a difference between the detected input volume value and the detected circuit volume value, determines whether the calculated volume value satisfies the leakage condition, and then finally determines whether a leakage occurs in the second hydraulic circuit by comparing the pressure value of the second hydraulic circuit with the target pressure and determining whether a condition, in which a second circuit pressure value is less than 80% of a target pressure value, is satisfied.

The determination part calculates a difference between the circuit volume value and the input volume value, which is detected at least three times, to determine the occurrence of the leakage in the second hydraulic circuit, and then determines a volume caused by the occurrence of leakage on the basis of the value.

In this case, because the time required to determine the occurrence of the leakage is directly related to under-braking, a stabilization section is provided for 50 ms only during the first determination process in order to minimize the determination time and improve the detection performance. That is, in case that the stabilization section is not provided, an instantaneous error may occur at the time of calculating a leakage rate. Further, whether a leakage occurs is continuously determined a total of two or more times for 100 ms.

Next, when the determination result in the determination step indicates that a leakage occurs, a step of performing control to stop the low-pressure pressing mode, switch the mode to the high-pressure pressing operation mode, and detect the leakage occurrence valve among the plurality of valves is performed (S130).

More specifically, in the high-pressure pressing operation mode, the first to fifth control valves 241, 231, 232, 233, and 54 of the second hydraulic circuit 202 operate to detect the control valve from which a leakage occurs among the plurality of control valves. The first to fifth control valves 241, 231, 232, 233, and 54 operate in a normal-closed state and a normal-open state in accordance with valve types, and then the control part performs control so that the determination part 420 consistently and repeatedly determines whether a leakage occurs in the second hydraulic circuit 202.

For example, because the first control valve 241 is the normal open type, the first control valve 241 switches to the closed state when operating. Because the second control valve 231 is in the normal closed state, the second control valve 231 switches to the open state when operating.

The third control valve 232, the fourth control valve 233, and the fifth control valve 54 are in the normal close state, the third control valve 232, the fourth control valve 233, and the fifth control valve 54 switch to the open state when operating.

In other words, unlike the low-pressure pressing mode of the hydraulic pressure supply device, the second control valve 231 (BV) is opened, and the first control valve (PDV) 241 is closed in the high-pressure pressing operation mode. That is, when the leakage is eliminated while the process of detecting a leakage is performed when the control is performed in the high-pressure pressing operation mode, the leakage point is determined as the second control valve (BV) because the first control valve 241 is in the closed state.

However, when a leakage continuously occurs even though the mode has been switched to the high-pressure pressing operation mode, it may be determined that a leakage occurs in the second cut valve (CUTS).

When the leakage occurrence valve is detected in the step of determining whether a leakage occurs in the second hydraulic circuit, a step of opening the first and second cut valves and performing control to switch the mode to the fall-back mode is performed (S140). In this case, in a detected braking cycle, the control part normally opens the first cut valve (CUTV (P)) 261 and the second cut valve (CUTV(S)) 262 to ensure a braking force higher than a braking force in the fall-back mode by adding a force, which is applied by the motor, to the pedal effort applied to the pedal by the driver.

Next, after the step of performing control to switch the mode to the fall-back mode, a step of recording diagnostic trouble code (DTC) information and providing driver notification by turning on the warning lamp is performed (S150).

Therefore, as described above, it is possible to detect the leakage occurrence valve of the secondary circuit cut valve (hereinafter, referred to as a ‘CUTV(S)’) of the electronic brake system (the integrated dynamic brake for a vehicle (hereinafter, referred to as an ‘IDB’) of the present disclosure, thereby reducing a non-detected failure region and improving stability by maximally ensuring the braking force for the detection time.

It will be appreciated that the embodiments of the present disclosure have been described above for purposes of illustration, and those skilled in the art may understand that the present disclosure may be easily modified in other specific forms without changing the technical spirit or the essential features of the present disclosure. Therefore, it should be understood that the above-described embodiments are illustrative in all aspects and do not limit the present disclosure. For example, each component described as a single type may be carried out in a distributed manner. Likewise, components described as a distributed type can be carried out in a combined type.

The scope of the present disclosure is represented by the claims to be described below rather than the detailed description, and it should be interpreted that the meaning and scope of the claims and all the changes or modified forms derived from the equivalent concepts thereto fall within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An electronic brake system, which comprises different first and second hydraulic circuits configured to transmit hydraulic pressure, which is discharged in a low-pressure pressing mode state or a high-pressure pressing operation mode state of a hydraulic pressure supply device, to a wheel cylinder provided on at least one vehicle wheel, the electronic brake system comprising:
a plurality of valves provided in hydraulic pressure flow path that connects the hydraulic pressure supply device and the first and second hydraulic circuits, the plurality of valves being configured to regulate hydraulic pressure;
a volume detection part configured to detect an input volume value of a pressure chamber produced when a motor piston is moved by a rotational force of a motor corresponding to a pedal effort measured by a pedal displacement sensor, and compute and detect, as a circuit volume value, a pressure value of the second hydraulic circuit measured by a pressure sensor;
a determination part configured to compare the circuit volume value with the input volume value detected by the volume detection part, determine whether a predetermined condition is satisfied, and determine whether a leakage occurs in the second hydraulic circuit; and
a control part configured to perform control to stop the low-pressure pressing mode, switch the mode to the high-pressure pressing operation mode, and detect a leakage occurrence valve among the plurality of valves when the determination part determines that a leakage occurs.

2. The electronic brake system of claim 1, wherein the pressure sensor measures hydraulic pressure to be transmitted to at least one wheel cylinder of the second hydraulic circuit, and the pedal displacement sensor measures a driver's pedal effort.

3. The electronic brake system of claim 1, wherein the determination part determines whether a leakage occurs in the second hydraulic circuit by calculating a difference between the input volume value and the circuit volume value, determining whether the predetermined condition is satisfied, comparing the pressure value of the second hydraulic circuit with target pressure, and then determining whether the predetermined condition is satisfied.

4. The electronic brake system of claim 3, wherein the determination part determines whether a leakage occurs by performing, at least three times, a process of determining whether a leakage occurs in the second hydraulic circuit.

5. The electronic brake system of claim 1, wherein the plurality of valves comprises a second cut valve, a first control valve, a second control valve, a third control valve, a fourth control valve, and a fifth control valve between the hydraulic pressure supply device and the second hydraulic circuit.

6. The electronic brake system of claim 5, wherein when the determination part determines that a leakage occurs, the control part switches the mode to the high-pressure pressing operation mode of the hydraulic pressure supply device, operates the first control valve of the second hydraulic circuit in a closed state, operates the second control valve in an open state, and then performs control to allow the determination part to repeatedly determine whether a leakage occurs in the second hydraulic circuit.

7. The electronic brake system of claim 6, wherein when the determination part determines that no leakage occurs in the high-pressure pressing operation mode state, the control part detects the second control valve as the leakage occurrence valve.

8. The electronic brake system of claim 6, wherein when the determination part determines that a leakage occurs in the high-pressure pressing operation mode state, the control part detects the second cut valve as the leakage occurrence valve.

9. The electronic brake system of claim 6, wherein when the determination part determines that a leakage occurs in the high-pressure pressing operation mode state, the control part performs control to open the first and second cut valves and switch the mode to a fall-back mode.

10. The electronic brake system of claim 6, wherein when the determination part determines that a leakage occurs in the high-pressure pressing operation mode state, the control part records diagnostic trouble code (DTC) information, turns on a warning lamp, and switches a state to an IDC control inhibition state after a braking cycle is ended.

11. A method of controlling an electronic brake system, which comprises different first and second hydraulic circuits configured to transmit hydraulic pressure, which is discharged in a low-pressure pressing mode state or a high-pressure pressing operation mode state of a hydraulic pressure supply device, to a wheel cylinder provided on at least one vehicle wheel, the method comprising:
detecting an input volume value of a pressure chamber produced when a motor piston is moved by a rotational force of a motor corresponding to a pedal effort measured by a pedal displacement sensor, and computing and detecting, as a circuit volume value, a pressure value of the second hydraulic circuit measured by a pressure sensor;
comparing the circuit volume value with the detected input volume value, determining whether the volume value satisfies a predetermined condition, and determining whether a leakage occurs in the second hydraulic circuit; and
performing control to stop the low-pressure pressing mode, switch the mode to the high-pressure pressing operation mode, and detect a leakage occurrence valve among the plurality of valves when the determination result, in the determining of whether a leakage occurs, indicates that a leakage occurs.

12. The method of claim 11, wherein the pressure sensor measures hydraulic pressure to be transmitted to at least one wheel cylinder of the second hydraulic circuit, and the pedal displacement sensor measures a driver's pedal effort.

13. The method of claim 11, wherein in the determining of whether a leakage occurs in the second hydraulic circuit, whether a leakage occurs in the second hydraulic circuit is determined by comparing the circuit volume value with the input volume value, determining whether the predetermined condition is satisfied, comparing a pressure value of the second hydraulic circuit with target pressure, and then determining whether the predetermined condition is satisfied.

14. The method of claim 13, wherein in the determining of whether a leakage occurs in the second hydraulic circuit, a process of determining whether a leakage occurs in the second hydraulic circuit is performed at least three times.

15. The method of claim 14, wherein during the process of determining whether a leakage occurs in the second hydraulic circuit by performing the process at least three times, the process of determining whether a leakage occurs is performed so that the time required to determine the occurrence of a first leakage is shorter than the time required to determine the occurrence of a second leakage or a later leakage.

16. The method of claim 11, further comprising:
switching the mode to the high-pressure pressing operation mode of the hydraulic pressure supply device, operating a first control valve of the second hydraulic circuit in a closed state, operating a second control valve in an open state, and then performing control to allow a determination part to repeatedly determine whether a leakage occurs in the second hydraulic circuit when the determination result, in the determining of whether a leakage occurs in the second hydraulic circuit, indicates that a leakage occurs.

17. The method of claim 16, wherein the second control valve is detected as the leakage occurrence valve when the determination result, in the determining of whether a leakage occurs in the second hydraulic circuit, indicates that no leakage occurs.

18. The method of claim 16, wherein a second cut valve is detected as the leakage occurrence valve when the determination result, in the determining of whether a leakage occurs in the second hydraulic circuit, indicates that a leakage occurs.

19. The method of claim 11, further comprising:
performing control to open first and second cut valves and switch the mode to a fall-back mode when the leakage occurrence valve is detected in the performing of the control to detect the leakage occurrence valve among the plurality of valves.

20. The method of claim 19, further comprising:
recording diagnostic trouble code (DTC) information and displaying notification to a driver by turning on a warning lamp after the performing of the control to switch the mode to the fall-back mode.
